(19) United States
(12) Patent Application Publication
(10) Pub. No.: US 2004/0117791 A1
(43) Pub. Date: Jun. 17, 2004

(54) Apparatus, system and method for limiting latency

(76) Inventors: Ajith Prasad, Bangalore (IN); Jain Philip, Bangalore (IN); Ananthan Ayyasamy, Bangalore (IN); Prabhanjan Moleyar, Bangalore (IN)

Correspondence Address: BUCKLEY, MASCHOFF, TALWALKAR LLC, 5 ELM STREET, NEW CANAAN, CT, 06840, US

(21) Appl. No.: 10/321,054

(22) Filed: Dec. 17, 2002

(51) Int. Cl. G06F 9/46

(52) U.S. Cl. 718/100

(57) ABSTRACT

A method, apparatus, and system for limiting latency.

### BACKGROUND OF THE INVENTION

In certain computer networks including, for example, the Internet, nodes multitask, or perform more than one task concurrently or nearly concurrently. Such multitasking may be performed, for example, by switching between such tasks being executed by a processor or by performing those tasks in different portions of the processor.

Tasks to be performed may be placed in a queue. Once a task has been completed that task may then be removed from the queue. Tasks may, furthermore have priorities associated with them such that high priority tasks are executed before low priority tasks. Where many high priority tasks are in the queue or are regularly added to the queue, execution of low priority tasks may be delayed for a long period of time. Moreover, while a low priority task may not require immediate execution, it may be important that the low priority task be executed within a certain period of time. Thus, there is a need for a system, an apparatus, and a method that causes a low priority task to be executed within a prescribed time period while minimally interfering with the execution of high priority tasks.

### BRIEF DESCRIPTION OF THE DRAWINGS

The subject matter regarded as embodiments of the invention is particularly pointed out and distinctly claimed in the concluding portion of the specification. Embodiments, however, both as to organization and method of operation, together with objects, features, and advantages thereof, may best be understood by reference to the following detailed description wherein like reference numerals are employed to designate like parts or steps, when read with the accompanying drawings in which:

FIG. 1 is a block diagram of a system suitable for practicing an embodiment of the invention;

FIG. 2 is a block diagram of a device suitable for practicing an embodiment of the invention;

FIG. 3 is a single timer latency limiting device suitable for practicing an embodiment of the invention;

FIG. 4 is a flowchart depicting a method of limiting latency in an embodiment of the invention; and

FIG. 5 is a pipeline in which an embodiment of the invention may be utilized.

### DETAILED DESCRIPTION OF THE INVENTION

Reference will now be made in detail to the preferred embodiments of the present invention, examples of which are illustrated in the accompanying drawings. It is to be understood that the Figures and descriptions of embodiments of the present invention included herein illustrate and describe elements that are of particular relevance, while eliminating, for purposes of clarity, other elements found in typical computers and computer networks.

The latency limitation techniques described herein provide solutions to the shortcomings of certain task prioritization techniques. Those of ordinary skill in task prioritization technology will readily appreciate that the latency limitation techniques, while described in connection with nodes communicating packets on a network, is equally applicable to other latency limitation applications including limitation of latency of items in a queue utilized internally to a single node or a queue that communicates information in any format over a network. Other details, features, and advantages of the latency limitation techniques will become further apparent in the following detailed description of the embodiments.

Any reference in the specification to “one embodiment,” “a certain embodiment,” or a similar reference to an embodiment is intended to indicate that a particular feature, structure, or characteristic described in connection with the embodiment is included in at least one embodiment of the invention. The appearances of such terms in various places in the specification are not necessarily all referring to the same embodiment. References to “or” are furthermore intended as inclusive so “or” may indicate one or the other ored terms or more than one ored term.

The Internet is a network of nodes such as computers, dumb terminals, or other typically processor-based, devices interconnected by one or more forms of communication media. Typical interconnected devices range from handheld computers and notebook PCs to high-end mainframe and supercomputers. The communication media coupling those devices include twisted pair, co-axial cable, optical fibers and wireless communication techniques such as use of radio frequency.

A node is any device coupled to the network including, for example, routers, switches, servers, and clients. Nodes may be equipped with hardware, software or firmware used to communicate information over the network in accordance with one or more protocols. A protocol may comprise a set of instructions by which the information signals are communicated over a communications medium. Protocols are, furthermore, often layered over one another to form something called a “protocol stack.” In one embodiment, the network nodes operate in accordance with a packet switching protocol referred to as the Transmission Control Protocol (TCP) as defined by the Internet engineering Task Force (IETF) standard 7, Request for Comment (RFC) 793, adopted in September, 1981 (TCP Specification), and the Internet Protocol (IP) as defined by IETF standard 5, RFC 791 (IP Specification), adopted in September, 1981, both available from www.ietf.org (collectively referred to as the “TCP/IP Specification”).

Nodes may operate as source nodes, destination nodes, intermediate nodes or a combination of those source nodes, destination nodes, and intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include data to be utilized by the node in which the data resides, data to be transferred to another node and utilized therein, and so forth.

Tasks to be performed by a node are sometimes placed in a queue to be executed as capacity in the node becomes free to perform the task. When a node is not busy and has no tasks in its queue, that node may execute each task that it receives in the order received without necessitating use of a queue. When tasks are received and the node is busy, however, the new tasks may be placed in the queue.

Those tasks that are placed in the queue may have associated priorities wherein a task with a high priority is to be executed before a task with a lower priority. For example, each task placed in the queue may be assigned a priority of zero to nine, with zero being the lowest priority and nine being the highest priority. In such a priority structure, the queued task having the highest priority may be performed first when the node has resources available to handle a task from the queue. Where tasks of equal priority reside in the queue, the earliest received task may be performed first. Thus, the highest priority tasks are handled at the earliest time.

Alternately, multiple queues may be utilized to store tasks having varying levels of priority. For example, high priority tasks may be placed in a high priority queue, medium priority tasks may be placed in a medium priority queue, and low priority tasks may be placed in a low priority queue. In such a case, tasks in the high priority queue are normally performed before tasks in the medium and low priority queues. When the high priority queue is empty, tasks in the medium priority queue are performed before tasks in the low priority queue. Tasks in the low priority queue are normally performed only when the high and medium priority queues are empty. Thus, the highest priority tasks are again handled at the earliest time.

In a very busy node, where additional tasks are received before the queue is emptied for an extended period of time, low priority tasks may not be performed throughout that period of time. Such a situation may be undesirable where a maximum limit on latency, or hold time prior to performing those low priority tasks, is desired. Accordingly, latency limitation embodiments are presented herein that cause one or more low priority tasks to be executed within a prescribed time period while minimally interfering with the execution of higher priority tasks.

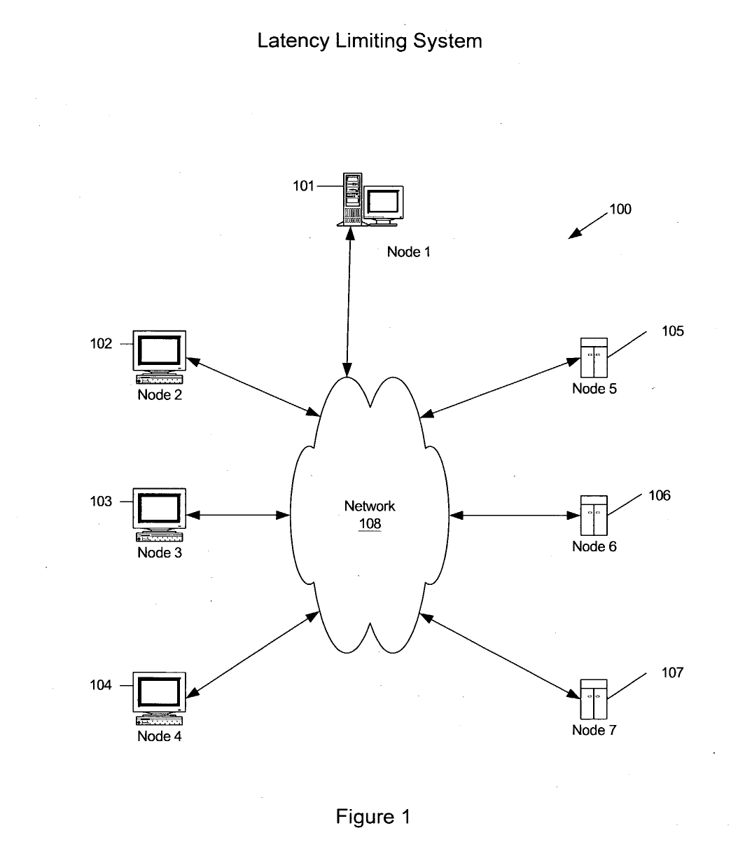

FIG. 1 illustrates a latency limiting system 100 in which embodiments of the present invention may be implemented. Node 1 101 may be a network server. Node 2 102, node 3 103, and node 4 104 may be general purpose computers or client processors. Node 5 105, node 6 106, and node 7 107 may be network routers or switches. Any of those nodes 101-107 may include an implementation of an embodiment of the latency limitation invention. The nodes 101-107 illustrated in FIG. 1 are coupled to a network 108 and may communicate therewith, although embodiments of latency limitation may be implemented on stand alone nodes.

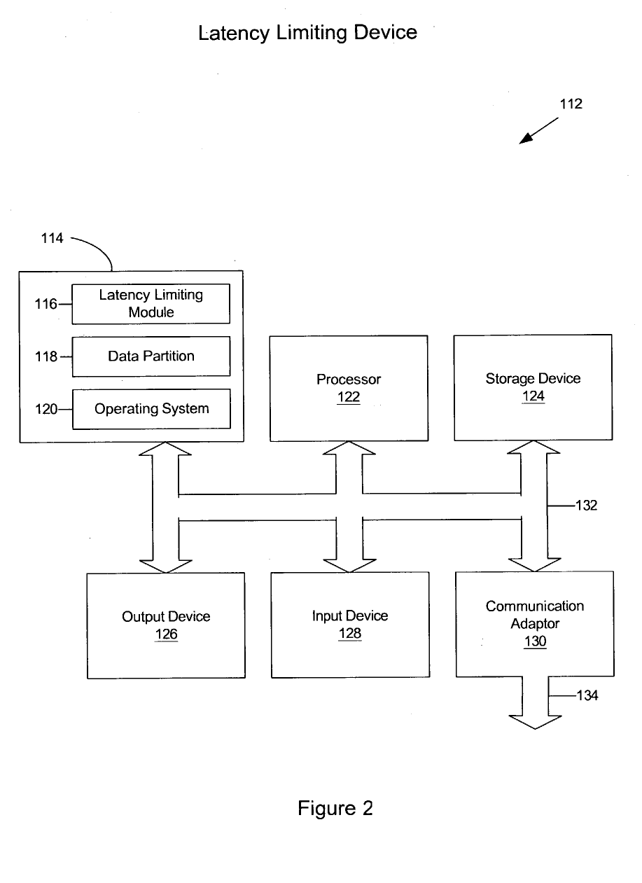

FIG. 2 illustrates a latency limiting device 112 in an embodiment in which latency limitation is performed in a router or switch. That latency limiting device 112 includes memory 114, a processor 122, a storage device 124, an output device 126, an input device 128, and a communication adaptor 130. It should be recognized that any or all of the components 114-134 of the latency limiting device 112 may be implemented in a single machine. For example, the memory 114 and processor 122 might be combined in a state machine or other hardware based logic machine. Communication between the processor 122, the storage device 124, the output device 126, the input device 128, and the communication adaptor 130 may be accomplished by way of one or more communication busses 132. It should be recognized that the latency limitation device 112 may have fewer components or more components than shown in FIG. 2. For example, if a user interface is not desired, the input device 128 or output device 126 may not be included with the latency limitation device 112.

The memory 114 may, for example, include random access memory (RAM), dynamic RAM, and/or read only memory (ROM) (e.g., programmable ROM, erasable programmable ROM, or electronically erasable programmable ROM) and may store computer program instructions and information. The memory 114 may furthermore be partitioned into sections in which operating system 120 instructions are stored, a data partition 118 in which data is stored, and a latency limitation module 116 partition in which instructions for latency limitation may be stored. The latency limitation module 116 partition may also allow execution by the processor 122 of the program instructions to limit latency related to one or more nodes 101-107. The data partition 118 may furthermore store data to be used during the execution of the program instructions such as, for example, a queue of tasks to be performed.

The processor 122 may, for example, be an Intel® Pentium® type processor or another processor manufactured by, for example Motorola®, Compaq®, AMD®, or Sun Microsystems®. The processor 122 may furthermore execute the program instructions and process the data stored in the memory 114. In one embodiment, the instructions are stored in memory 114 in a compressed and/or encrypted format. As used herein the phrase, “executed by a processor” is intended to encompass instructions stored in a compressed and/or encrypted format, as well as instructions that may be compiled or installed by an installer before being executed by the processor.

The storage device 124 may, for example, be a magnetic disk (e.g., floppy disk and hard drive), optical disk (e.g., CD-ROM) or any other device or signal that can store digital information. The communication adaptor 130 may permit communication between the latency limiting device 112 and other devices or nodes coupled to the communication adaptor 130 at the communication adaptor port 134. The communication adaptor 130 may be a network interface that transfers information from nodes on a network to the latency limiting device 112 or from the latency limiting device 112 to nodes on the network. The network may be a local or wide area network, such as, for example, the Internet, the World Wide Web, or the latency limiting system 100 illustrated in FIG. 1. It will be recognized that the latency limiting device 112 may alternately or in addition be coupled directly to one or more other devices through one or more input/output adaptors (not shown).

The latency limiting device 112 may also be coupled to one or more output devices 126 such as, for example, a monitor or printer, and one or more input devices 128 such as, for example, a keyboard or mouse. It will be recognized, however, that the latency limiting device 112 does not necessarily need to have an input device 128 or an output device 126 to operate. Moreover, the storage device 124 may also not be necessary for operation of the latency limiting device 112.

The elements 114, 122, 124, 126, 128, and 130 of the latency limiting device 112 may communicate by way of one or more communication busses 132. Those busses 132 may include, for example, a system bus, a peripheral component interface bus, and an industry standard architecture bus.

Embodiments that perform the latency limiting technique provide optimum and efficient assurance that guaranteed service latency will be provided on low priority queues. In those embodiments, a queuing system may be constructed that limits service time, or the time that a task resides in a queue, for low priority tasks in the queue, while delaying performance of low priority tasks when higher priority tasks reside in the queue.

In one embodiment, a technique is utilized that causes an entry in a queue to be performed when a period of time passes. That period of time may be measured, for example, by counting a fixed number of clock cycles. In that embodiment, the period is predetermined. That embodiment, however, does not ensure service latency for every entry in the queue, it only ensures a service rate. That is because multiple entries might arrive in the queue within the fixed time period. All but the highest priority task received during the time period would, therefore, not be performed during that time. Moreover, one or more additional tasks may be received during the next time period so that the lowest priority tasks could be stuck in the queue indefinitely. That technique, therefore, may not ensure that the latency of a low priority task is limited because it may not ensure that that task is performed in a prescribed period of time from its receipt. That technique may also service a lower priority task that is received near the end of the time period prior to servicing a higher priority task that is received at approximately the same time.

In another embodiment, the technique that causes an entry in a queue to be performed once every fixed time period is modified to perform every task in the queue each time the time period expires. That technique, therefore, ensures that every task is performed within the time period. Note that while the time period is fixed, tasks enter the queue at random times during that period. A drawback to that technique, therefore, is that it may be inefficient because the low priority tasks are treated as high priority tasks each time the predetermined number of clock cycles passes, and that may be sooner than was necessary because those low priority tasks may have recently arrived in the queue. That results in unnecessary delay for higher priority tasks in the queue.

In another embodiment, a latency timer is associated with every entry in the queue. A service latency threshold is also established. When the latency timer for a task reaches a service latency threshold, priority may be inverted so that the low priority task reaching the threshold is performed at that time. That embodiment achieves the desired result of causing one or more low priority tasks to be performed within a prescribed time period while minimally interfering with the execution of higher priority tasks. That embodiment, however, also requires D N-bit counters, where D is the number of tasks that are or may be placed in the queue and N is the number of bits required to represent the service latency threshold.

A single timer embodiment also achieves the desired result of causing one or more low priority tasks to be executed within a prescribed time period while minimally interfering with the execution of higher priority tasks while requiring less memory or area overhead than D N-bit counters. In that embodiment, only a single N-bit counter is required. That counter may count clock cycles and so may also be referred to as a timer. The value of that timer when a task is added to the queue may be stored in memory as a timestamp along with the entry in the queue. The queue may operate such that each task enters the queue in the order they are received with the oldest task residing at the head of the queue. Thus, the timer may be compared to the timestamp of the task at the head of the queue. When the difference between the timer and the timestamp of the task at the head of the queue is greater than the desired service latency threshold, a priority inversion may occur. When the priority inversion occurs, the task at the head of the queue may be performed even if its priority is less than one or more other tasks in that or another queue. In that way, no task will remain queued for longer than the service latency threshold. If the difference between the timer and the timestamp of the task at the head of the queue is less than the desired service latency threshold, a priority inversion may not occur.

In the single timer embodiment, the size of each queue entry may need to be increased to provide space for storage of the timestamp (N bits). In, for example, an application specific integrated circuit implementation where queues are stored in RAM or register files, the single counter embodiment will use less memory and power than the embodiment requiring D N-bit counters. That is because the embodiment requiring D N-bit counters may require additional registers and combinatorial logic. Similarly, in software it is a benefit that only one counter need be utilized. Thus a method of limiting queue latency may include storing a time stamp associated with a task when the task is placed in the queue, calculating a latency period by comparing the time stamp to a timer value, and servicing the task based on the latency period calculated.

A queue latency limiting device is contemplated. That queue latency limiting device includes a queue, a timer, control logic, and an arbiter. The queue may have a plurality of task fields and each task field may have a data field containing data and a time stamp field containing a value corresponding to a time when the data was placed in the data field. The task field that has been in the queue for the longest time may be referred to as a head task field. The timer may have a value that increases as time passes. The control logic may determine a latency period by comparing the time stamp value in the head task field to the timer value. That comparing may be performed by subtracting the time stamp value in the head task field to the timer value. The arbiter may then service the data field in the head task field when the latency period is greater than a predetermined time by, for example, reading the task from the queue and sending the task to the processor 122 for execution.

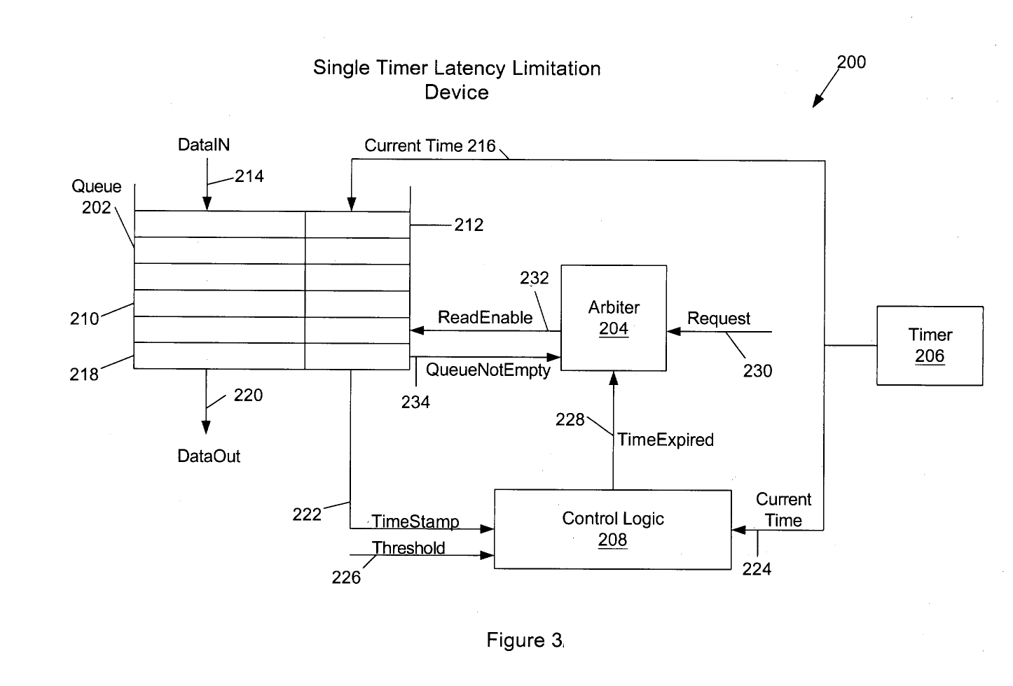

FIG. 3 illustrates a single timer latency limiting device 200 that achieves a goal of servicing lower priority queues either when all higher priority queues are empty or when the service latency threshold has passed. That single timer device 200 includes a queue 202, an arbiter 204, a timer 206 and control logic 208. The queue 202 is a queue of a given priority in an arrangement wherein there is at least one additional queue having a priority greater than the depicted queue 202. The queue 202 includes a data field 210 and a timer field 212. Information or data that describes one or more tasks to be performed is placed in the data field 210 at 214 and the time at which each task is placed in the queue 202 is retrieved from the timer 206 and placed in the timer field 212 at 216. The head of the queue 218 is illustrated at the bottom of the queue 202 and each time a task at the head of the queue 218 is performed it is removed from the queue 202 at 220.

The control logic 208 determines whether the threshold has passed for the task at the head of the queue 202. Periodically the control logic 208 will retrieve a value from the time stamp for the task at the head of the queue 218 at 222. That period may be the time it takes to perform an arbitration, which in a hardware implementation could be a single clock period. The control logic 208 also retrieves the current time from the timer 206 at 224. The control logic 208 then compares the difference between the retrieved time stamp value and the current time to the threshold.

The current time may periodically return to a minimum value. For example, if the current time is less than the time stored in the time stamp, then the timer 206 may be assumed to have rolled over to zero and begun counting up from there again. In such a situation, a one may be placed in the most significant position of the current time read by the control logic 208 prior to comparing the current time to the value held in the time stamp. That may be represented by the pseudocode:

If currenttime>timestampvalue

timeexpired=(currenttime−timestampvalue)

else

timeexpired=((1′b1, currenttime)−timestampvalue)

where “1′b1, currenttime” is equal to the binary value of currenttimer with a “1” placed in the most significant position of the binary value of currenttimer. It should be recognized that the threshold, current time, and time stamp value may be in units of time or number of clock cycles.

The arbiter 204 reads a task from the head of the queue 202 when all higher priority queues are empty or when the control logic 208 indicates that the threshold has been exceeded. The control logic 208 provides a time expired signal 228 to the arbiter 204 when the threshold has been exceeded for the task at the head of the queue 202. A requester, such as the processor 122 of FIG. 2, provides a request signal 230 requesting a task when all higher priority queues are empty. When the arbiter 204 receives either the time expired signal 228 or the request signal 230, the arbiter 204 transmits a read enable signal 232 to the queue 202. The queue 202 responds to the read enable signal 232 by removing the task at the head of the queue 220 from the queue 202 and transmitting that task to the arbiter 204 in a queue not empty signal 234. If the queue 202 is empty, which may happen, for example, when a request signal 230 is received at the arbiter 204, then the queue will respond to the read enable signal 232 with a message indicating that the queue 202 is empty.

When a task is read from the queue 202, the task may be transferred to, for example, a processor such as the processor 122 of FIG. 2 and the task may be executed by the processor 122 and so performed.

An article of manufacture is also contemplated. The article of manufacture includes a computer readable medium having stored thereon. When the instructions are executed by a processor, the processor stores a time stamp associated with a task when the task is placed in the queue, calculates a latency period by comparing the time stamp to a timer value, and services the task when the latency period is greater than a predetermined time.

A system that limits queue latency is furthermore contemplated. That system includes a first queue, a second queue, a timer, a control logic, and an arbiter. The first queue has a first priority and a plurality of task fields. The second queue has a second priority lower than the first priority and a plurality of task fields, each task field having a data field containing data and a time stamp field containing a value corresponding to a time when the data was placed in the data field. The task field that has been in the queue for the longest time is referred to as a head task field for the second queue. The timer has an incrementing value and the control logic determines a latency period by comparing the time stamp value in the head task field for the second queue to the timer value. The arbiter services the data field in the head task field for the second queue when the latency period is greater than a predetermined time regardless of whether a task exists in the first queue.

Moreover, a service class for network traffic with limited service latency on a low priority queue is contemplated. The service class associates a time stamp with a task when the task is placed in the queue, calculates a latency period by comparing the time stamp to a timer value, and services the task based on the latency period calculated.

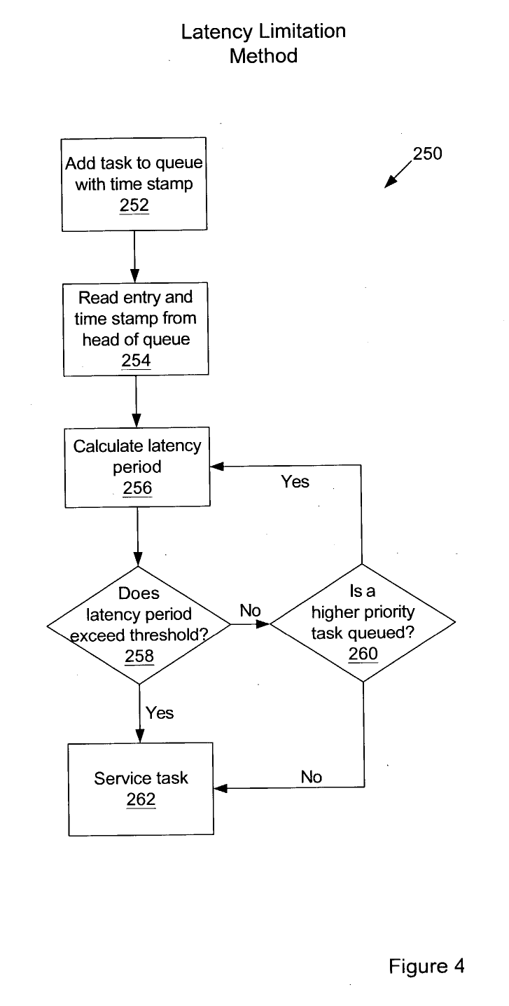

FIG. 4 illustrates a method of limiting latency 250. The latency limiting method 250 is directed to limitation of latency in a low priority queue. The latency limiting method 250 includes reading a task and an associated time stamp from the low priority queue at 254, calculating a latency period at 256, and servicing the task when the latency period exceeds a predetermined threshold time at 258-262.

At 252, tasks may be stored in the low priority queue along with an associated time stamp as they are received. The latency period may be calculated at 256 by subtracting the time stamp of the task that has resided in the queue for the longest time from a timer value. The threshold time may be a maximum amount of time that a low priority task is desired to be held in the queue and may be predetermined. If the calculated latency period exceeds or is equal to the threshold at 258, the task is serviced at 262. If the calculated latency is less than the threshold at 258, a higher priority task is sought at 260. If a higher priority task is found at 260, then the higher priority task may be serviced and the method returns to 256 to recalculate the latency period with a new timer value. If a higher priority task is not found at 260, then the low priority task is serviced at 262.

When a task is serviced, it may be read from the queue, removed from the queue, and performed by, for example, executing the task in the processor 122 of FIG. 2.

With regard to the timer value, it may be incremented as time passes and held in a limited space such as a byte of limited size. Thus, that timer value may periodically return to a minimum value such as zero. To adjust for roll over, a one may be placed in the most significant position of the timer value when the time stamp value is greater than or equal to the timer value. Alternately, other schemes that compare two circular pointers may be utilized when the timer is held in such a limited space.

It should be recognized that portions of the latency limiting method 250 may be performed simultaneously. For example, adding a task with a time stamp to the queue at 252 and determining whether a task should be performed at 254-260 may occur simultaneously.

Embodiments of the invention may be used to provide a service class at low priority with guaranteed service latency. For example, embodiments are applicable in a packet switched network where a low priority service class exists that needs to have a guaranteed maximum service latency in order not to experience packet loss or to guarantee quality of service or usefulness of the packet data and a higher priority service class exists that requires faster service.

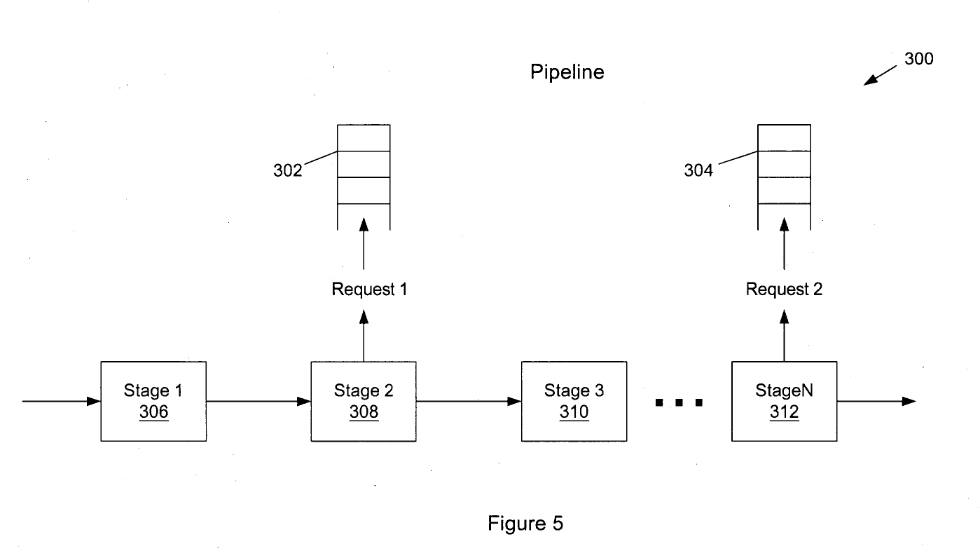

FIG. 5 illustrates a pipeline 300 in which an embodiment of the present invention may be utilized. The pipeline 300 of FIG. 5 includes two requests generated from different parts of the pipeline 300 depicted as Request1 302 and Request2 304. The pipeline 300 also depicts four of at least N stages, Stage1 306, Stage2 308, Stage3 310, and StageN 312, wherein N is a subset of the total number of stages in the pipeline 300. Request2 304 has a high priority because, for example, the pipeline 300 may not move past StageN 312 until Request2 304 is serviced. Request1 302 has a low priority because, for example, the pipeline 300 can move forward from Stage1 306 to StageN 312 regardless of whether Request1 302 is serviced. At least one aspect of Request2 304, however, may not be performed until Request1 302 is executed. Thus, Request2 304 is dependent on Request1 302. Those requests 302 and 304, furthermore, enter the pipeline 300 at different points; Request1 entering the pipeline 300 at Stage 2 308 and Request2 304 entering the pipeline 300 at StageN 312.

The requests 302 and 304 may be handled by a latency limitation device such as the latency limitation device 200 of FIG. 3 to maintain Request2 304 at a high priority while guaranteeing that Request1 302 will be performed within the service latency time so that Request2 304 can be complete at or soon after StageN 312. To accomplish that, the threshold time may set such that the service latency for Request1 302 is no more than the minimum time that it would take for an entry to proceed through the pipeline 300 from Stage2 308 to StageN 312. In that way, Request1 302 can be maintained at a low priority but still be assured to be serviced by the time Request2 304 enters the pipeline 300 at StageN 312.

While the latency limitation systems, apparatuses, and methods have been described in detail and with reference to specific embodiments thereof, it will be apparent to one skilled in the art that various changes and modifications can be made therein without departing from the spirit and scope thereof. For example, the latency limitation systems, apparatuses, and methods may be applied to queues having priorities, whether stored in a single queue or multiple queues. Thus, it is intended that the present invention cover the modifications and variations of this invention provided they come within the scope of the appended claims and their equivalents.

What is claimed is:

1. A queue latency limitation method, comprising:
storing a time stamp associated with a task when the task is placed in the queue;
calculating a latency period by comparing the time stamp to a timer value; and
servicing the task based on the latency period calculated.

2. The method of claim 1, wherein the timer value increments as time passes.

3. The method of claim 2, wherein the timer value periodically returns to a minimum value.

4. The method of claim 3, wherein the minimum value is zero.

5. The method of claim 4, wherein a one is placed in the most significant position of the timer value when the time stamp value exceeds the timer value.

6. The method of claim 4, wherein a one is placed in the most significant position of the timer value when the time stamp value is equal to the timer value.

7. The method of claim 1, further comprising removing the task from the queue.

8. The method of claim 1, wherein servicing the task includes reading the task from the queue and performing the task.

9. The method of claim 1, wherein a plurality of tasks reside in the queue and the time stamp compared is a time stamp associated with a task that has resided in the queue for the longest time.

10. The method of claim 1, wherein the task and the time stamp are stored in a field in the queue.

11. The method of claim 1, wherein the task is serviced when the latency period reaches a maximum amount of time that a low priority task is desired to be held in the queue.

12. The method of claim 1, wherein the latency period is calculated by subtracting the time stamp from the timer value.

13. The method of claim 1, wherein the timer value decrements as time passes.

14. A queue latency limitation device, comprising:
a queue having a plurality of task fields, each task field having a data field containing data and a time stamp field containing a value corresponding to a time when the data was placed in the data field, the task field that has been in the queue for the longest time being a head task field;
a timer having an incrementing value;
control logic determining a latency period by comparing the time stamp value in the head task field to the timer value; and
an arbiter that services the data field in the head task field when the latency period is greater than a predetermined time.

15. The queue latency limitation device of claim 14, wherein the timer value periodically returns to a minimum value.

16. The queue latency limitation device of claim 15, wherein the minimum value is zero.

17. The queue latency limitation device of claim 16, wherein a one is placed in the most significant position of the timer value when the time stamp value exceeds the timer value.

18. The queue latency limitation device of claim 16, wherein a one is placed in the most significant position of the timer value when the time stamp value is equal to the timer value.

19. The queue latency limitation device of claim 14, wherein a plurality of tasks reside in the queue and the time stamp compared is a time stamp associated with a task that has resided in the queue for the longest time.

20. The queue latency limitation device of claim 14, wherein comparing the time stamp value in the head task field to the timer value further comprises subtracting the time stamp value in the head task field from the timer value.

21. An article of manufacture comprising:
a computer readable medium having stored thereon instructions which, when executed by a processor, cause the processor to:
store a time stamp associated with a task when the task is placed in the queue;
calculate a latency period by comparing the time stamp to a timer value; and
service the task when the latency period is greater than a predetermined time.

22. The article of manufacture of claim 21, wherein a plurality of tasks reside in the queue and a time stamp associated with a task that has resided in the queue for the longest time is subtracted from the timer value when calculating the latency period.

23. The article of manufacture of claim 21, wherein the task is serviced when the latency period is greater than or equal to a predetermined time.

24. A queue latency limitation system, comprising:
a first queue having a first priority and a plurality of task fields;
a second queue having a second priority lower than the first priority and a plurality of task fields, each task field having a data field containing data and a time stamp field containing a value corresponding to a time when the data was placed in the data field, the task field that has been in the queue for the longest time being a head task field for the second queue;
a timer having an incrementing value;
control logic determining a latency period by comparing the time stamp value in the head task field for the second queue to the timer value; and
an arbiter that services the data field in the head task field for the second queue when the latency period is greater than a predetermined time regardless of whether a task exists in the first queue.

25. The queue latency limitation system of claim 24, wherein comparing the time stamp value in the head task field for the second queue to the timer value further comprises subtracting the time stamp value in the head task field for the second queue from the timer value.

26. A service class for network traffic with limited service latency on a low priority queue, comprising:
associating a time stamp with a task when the task is placed in the queue;
calculating a latency period by comparing the time stamp to a timer value; and
servicing the task based on the latency period calculated.

27. The service class of claim 26, wherein a plurality of tasks reside in the low priority queue and the time stamp compared is a time stamp associated with a task that has resided in the queue for the longest time.

28. The service class of claim 26, wherein comparing the time stamp value to the timer value further comprises subtracting the time stamp value from the timer value.
